(19) United States
(12) Patent Application Publication
(10) Pub. No.: US 2025/0136828 A1
(43) Pub. Date: May 1, 2025

(54) COMPOSITION FOR ULTRAVIOLET LIGHT REFLECTION

(71) Applicant: DENKA COMPANY LIMITED, Chuo-ku, Tokyo (JP)

(72) Inventors: Shota SOTOKAWA, Tokyo (JP); Takeshi ASAMI, Tokyo (JP); Hitoshi KANEKO, Tokyo (JP)

(73) Assignee: DENKA COMPANY LIMITED, Chuo-ku, Tokyo (JP)

(21) Appl. No.: 18/694,095

(22) PCT Filed: Sep. 30, 2022
(86) PCT No.: PCT/JP2022/036802

§ 371 Date: Mar. 21, 2024

(30) Foreign Application Priority Data
Oct. 15, 2021 (JP) 2021-169389

(51) Int. Cl. C09D 7/61; C09D 5/33; C09D 127/16; C09D 127/20

(52) U.S. Cl. CPC C09D 7/61; C09D 5/004; C09D 127/16; C09D 127/20

(57) ABSTRACT

A composition for ultraviolet light reflection, the composition containing a base material and zirconium oxide particles dispersed in the base material, in which the base material contains a fluororesin, and a particle diameter D50 of the zirconium oxide particles is 10 μm or less.

### TECHNICAL FIELD

The present invention relates to a composition for ultraviolet light reflection, and the like.

### BACKGROUND ART

In recent years, there has been an increasing demand for sterilization using deep ultraviolet light (for example, light having a wavelength of 200 to 300 nm; hereinafter, referred to as “UVC”). For example, Patent Literature 1 below discloses a laminate having a protective layer containing a silicone composition and an aluminum foil supporting the protective layer, as a member that can be used in sterilization using UVC.

### CITATION LIST

### Patent Literature

Patent Literature 1: Japanese Unexamined Patent Publication No. 2018-118412

### SUMMARY OF INVENTION

### Technical Problem

In various applications using UVC, it may be required to reflect the UVC emitted from a light source. For example, in a sterilization apparatus or the like using UVC, in order to efficiently utilize the UVC emitted from the light source and prevent the UVC from leaking out of the apparatus, it may be required to reflect the UVC on the inner wall of the apparatus. Therefore, it is required for a composition for ultraviolet light reflection that can be used in reflection of the UVC in various applications to obtain a high reflectance with respect to the UVC, and particularly, to obtain a high reflectance with respect to light having a wavelength of 270 to 280 nm.

An object of an aspect of the present invention is to provide a composition for ultraviolet light reflection capable of obtaining a high reflectance with respect to light having a wavelength of 270 to 280 nm.

### Solution to Problem

In some aspects, the present disclosure relates to the following [1] to [12], and the like.
[1] A composition for ultraviolet light reflection, the composition containing a base material and zirconium oxide particles dispersed in the base material, in which the base material contains a fluororesin, and a particle diameter D50 of the zirconium oxide particles is 10 μm or less.
[2] The composition for ultraviolet light reflection described in [1], in which the particle diameter D50 of the zirconium oxide particles is 0.1 to 10 μm.
[3] The composition for ultraviolet light reflection described in [1], in which the particle diameter D50 of the zirconium oxide particles is 0.1 to 1.0 μm.
[4] The composition for ultraviolet light reflection described in any one of [1] to [3], in which a content of the zirconium oxide particles is 20 to 70% by mass based on the total mass of the zirconium oxide particles and the fluororesin.
[5] The composition for ultraviolet light reflection described in any one of [1] to [4], in which the fluororesin has at least one selected from the group consisting of vinylidene fluoride and hexafluoropropylene as a monomer unit.
[6] The composition for ultraviolet light reflection described in [5], in which the fluororesin has vinylidene fluoride and hexafluoropropylene as monomer units.
[7] The composition for ultraviolet light reflection described in [5] or [6], in which a content of the monomer unit of the vinylidene fluoride is 70 to 95% by mass based on the total mass of the monomer unit of the fluororesin.
[8] The composition for ultraviolet light reflection described in any one of [1] to [7], in which the base material is in a liquid state at 23° C.
[9] The composition for ultraviolet light reflection described in [8], in which the base material further contains an organic solvent.

[10] The composition for ultraviolet light reflection described in any one of [1] to [7], which has a film shape.

[11] The composition for ultraviolet light reflection described in [10], in which an average film thickness is 50 to 500 μm.

[12] The composition for ultraviolet light reflection described in or

[11], in which a content of the zirconium oxide particles is 10 to 40% by volume.

### Advantageous Effects of Invention

According to an aspect of the present invention, it is possible to provide a composition for ultraviolet light reflection capable of obtaining a high reflectance with respect to light having a wavelength of 270 to 280 nm.

### DESCRIPTION OF EMBODIMENTS

Hereinafter, embodiments of the present invention will be specifically described. However, the present invention is not limited to the following embodiments.

“A or more” of the numerical range means A and a range of more than A. “A or less” of the numerical range means A and a range of less than A. In the numerical ranges that are described stepwise in the present specification, the upper limit value or the lower limit value of the numerical range of a certain stage can be arbitrarily combined with the upper limit value or the lower limit value of the numerical range of another stage. In the numerical ranges that are described in the present specification, the upper limit value or the lower limit value of the numerical value range may be replaced with the value shown in Examples. “A or B” may include any one of A and B, and may also include both of A and B. Materials listed as examples in the present specification can be used alone or in combinations of two or more kinds thereof, unless otherwise specified. In a case where a plurality of substances corresponding to each component exist in the composition, the content of each component in the composition means the total amount of the plurality of substances that exist in the composition, unless otherwise specified. The term “step” includes not only an independent step but also a step by which an intended action of the step is achieved, though the step cannot be clearly distinguished from other steps. The solid content in a resin composition refers to a non-volatile content in the resin composition excluding a volatile content (such as water and an organic solvent). That is, this solid content refers to a component remaining without volatile in drying of the resin composition and also includes a component in a liquid state, a syrupy state, a waxy state, and the like at 23° C.

A composition for ultraviolet light reflection of the present embodiment (including compositions for ultraviolet light reflection of a first embodiment and a second embodiment described below; the same applies hereinafter) contains a base material and zirconium oxide particles dispersed in the base material, in which the base material contains a fluororesin, and a particle diameter D50 of the zirconium oxide particles is 10 μm or less.

According to the composition for ultraviolet light reflection of the present embodiment, a high reflectance with respect to light having a wavelength of 270 to 280 nm can be obtained as a reflectance with respect to deep ultraviolet light. According to the composition for ultraviolet light reflection of the present embodiment, a high reflectance can be obtained in a film-shaped composition for ultraviolet light reflection having an average film thickness of 10 μm or more (50 μm or more, 100 um or more, or the like), a reflectance of, for example, 40% or more (preferably, 50% or more, 60% or more, 70% or more, 80% or more, or the like) can be obtained in the evaluation method described in Examples below. The composition for ultraviolet light reflection of the present embodiment may be used to reflect light having a wavelength (wavelength band) different from a wavelength of 270 to 280 nm.

The present inventors infer the reasons why a high reflectance is obtainable as follows. However, the reasons are not limited to these contents.

Specifically, materials such as zirconium oxide and titanium oxide have semiconductor properties and tend to absorb light having a wavelength with energy greater than or equal to the band gap. A material having a relatively small band gap (for example, about 3 eV≈about 400 nm), such as titanium oxide, can absorb light having a wavelength of 270 to 280 nm, whereas zirconium oxide having a relatively large band gap (about 5 eV≈about 250 nm) is difficult to absorb light having a wavelength of 270 to 280 nm, so that a reflectance is likely to increase.

Furthermore, since the zirconium oxide particles have a high refractive index and the fluororesin is difficult to absorb light having a wavelength of 270 to 280 nm, light having a wavelength of 270 to 280 nm is not absorbed by the fluororesin of the base material and is easily scattered by the zirconium oxide particles. At this time, when the particle diameter D50 of the zirconium oxide particles is 10 μm or less, the number of particles per unit mass, total specific surface area, and the like in the particle group of the zirconium oxide particles of the entire composition are likely to increase, so that light is easily scattered efficiently, and thus the reflectance is likely to increase.

It is presumed that a high reflectance is obtainable by these actions.

The composition for ultraviolet light reflection of the present embodiment contains zirconium oxide particles. The zirconium oxide particles are particles containing zirconium oxide (for example, ZrO₂).

The zirconium oxide particles may be any of stabilized zirconia, partially stabilized zirconia, unstabilized zirconia, or the like. The zirconium oxide particles may contain a metal oxide other than zirconium oxide. Examples of such a metal oxide include hafnium oxide (for example, HfO₂), silicon oxide (for example, SiO₂), iron oxide (for example, Fe₂O₃), titanium oxide (for example, TiO₂), yttria oxide, cerium oxide, magnesium oxide, and calcium oxide. The zirconium oxide particles may contain hafnia-stabilized zirconia.

The total amount of the zirconium oxide and the hafnium oxide in the zirconium oxide particles may be in the following range based on the total mass of the zirconium oxide particles. The total amount may be 90% by mass or more, 93% by mass or more, 95% by mass or more, 98% by mass or more, 99% by mass or more, 99.5% by mass or more, or 99.8% by mass or more. The total amount may be less than 100% by mass, 99.9% by mass or less, or 99.8% by mass or less. From these viewpoints, the total amount may be 90% by mass or more and less than 100% by mass, 95 to 99.9% by mass, or 99 to 99.9% by mass.

The content of the silicon oxide in the zirconium oxide particles may be in the following range based on the total mass of the zirconium oxide particles. The content of the silicon oxide may be more than 0% by mass, 0.005% by mass or more, 0.01% by mass or more, 0.02% by mass or more, 0.03% by mass or more, 0.04% by mass or more, or 0.05% by mass or more. The content of the silicon oxide may be 0.5% by mass or less, 0.3% by mass or less, 0.1% by mass or less, 0.08% by mass or less, 0.06% by mass or less, or 0.05% by mass or less. From these viewpoints, the content of the silicon oxide may be more than 0% by mass and 0.5% by mass or less, 0.01 to 0.1% by mass, or 0.03 to 0.08% by mass.

A content A of at least one selected from the group consisting of the content of the iron oxide and the content of the titanium oxide in the zirconium oxide particles may be in the following range based on the total mass of the zirconium oxide particles. The content A may be more than 0% by mass, 0.001% by mass or more, 0.003% by mass or more, 0.005% by mass or more, 0.008% by mass or more, 0.009% by mass or more, or 0.01% by mass or more. The content A may be 0.2% by mass or less, 0.1% by mass or less, 0.08% by mass or less, 0.05% by mass or less, 0.04% by mass or less, 0.03% by mass or less, 0.02% by mass or less, or 0.01% by mass or less. From these viewpoints, the content A may be more than 0% by mass and 0.2% by mass or less, 0.001 to 0.1% by mass, or 0.005 to 0.05% by mass.

The particle diameter D50 of the zirconium oxide particles is 10 μm or less from the viewpoint of obtaining a high reflectance with respect to light having a wavelength of 270 to 280 nm. The particle diameter D50 of the zirconium oxide particles may be 8.0 μm or less, 5.0 μm or less, 3.0 μm or less, 2.0 μm or less, 1.0 μm or less, 0.9 μm or less, 0.8 μm or less, 0.7 μm or less, or 0.6 μm or less, from the viewpoint of easily obtaining a high reflectance. The particle diameter D50 of the zirconium oxide particles may be 0.5 μm or less or 0.4 μm or less. The particle diameter D50 of the zirconium oxide particles may be 0.01 μm or more, 0.05 μm or more, 0.1 μm or more, 0.2 μm or more, 0.3 μm or more, 0.4 μm or more, 0.5 μm or more, or 0.6 μm or more, from the viewpoint of easily obtaining a high reflectance. From these viewpoints, the particle diameter D50 of the zirconium oxide particles may be 0.01 to 10 μm, 0.1 to 10 μm, 0.1 to 5.0 μm, 0.1 to 1.0 μm, 0.1 to 0.5 μm, or 0.5 to 1.0 μm. The particle diameter D50 of the zirconium oxide particles can be measured by the method described in Examples below.

The crystallite size of the zirconium oxide particles may be 50 Å or more, 80 Å or more, 100 Å or more, 120 Å or more, 150 Å or more, 180 Å or more, 200 Å or more, or 220 Å or more, from the viewpoint of easily obtaining a high reflectance. The crystallite size of the zirconium oxide particles may be 1000 Å or less, 800 Å or less, 600 Å or less, 500 Å or less, 490 Å or less, 450 Å or less, 400 Å or less, 390 Å or less, 350 Å or less, 300 Å or less, 250 Å or less, or 230 Å or less, from the viewpoint of easily obtaining a high reflectance. The crystallite size of the zirconium oxide particles may be 220 Å or less, 200 Å or less, 180 Å or less, 150 Å or less, or 120 Å or less. From these viewpoints, the crystallite size of the zirconium oxide particles may be 50 to 1000 Å, 100 to 800 Å, 100 to 500 Å, 100 to 300 Å, 100 to 250 Å, 150 to 300 Å, or 100 to 150 Å. The crystallite size of the zirconium oxide particles can be measured by the method described in Examples below.

The BET specific surface area of the zirconium oxide particles may be 0.1 m²/g or more, 0.5 m²/g or more, 1 m²/g or more, 5 m²/g or more, 10 m²/g or more, 15 m²/g or more, 20 m²/g or more, or 22 m²/g or more, from the viewpoint of easily obtaining a high reflectance. The BET specific surface area of the zirconium oxide particles may be 25 m²/g or more, 30 m²/g or more, 40 m²/g or more, 50 m²/g or more, 60 m²/g or more, 70 m²/g or more, 80 m²/g or more, or 90 m²/g or more. The BET specific surface area of the zirconium oxide particles may be 200 m²/g or less, 150 m²/g or less, 100 m²/g or less, 90 m²/g or less, 80 m²/g or less, 70 m²/g or less, 60 m²/g or less, 50 m²/g or less, 40 m²/g or less, 30 m²/g or less, 25 m²/g or less, or 22 m²/g or less, from the viewpoint of easily obtaining a high reflectance. From these viewpoints, the BET specific surface area of the zirconium oxide particles may be 0.1 to 200 m²/g, 1 to 200 m²/g, 5 to 150 m²/g, 10 to 100 m²/g, 20 to 90 m²/g, 20 to 50 m²/g, or 50 to 90 m²/g. The BET specific surface area of the zirconium oxide particles can be measured by the method described in Examples below.

The content of the zirconium oxide particles may be in the following range based on the total mass of the zirconium oxide particles and the base material (solid content) or the total mass of the zirconium oxide particles and the fluororesin. The content of the zirconium oxide particles may be more than 0% by mass, 1% by mass or more, 5% by mass or more, 10% by mass or more, 15% by mass or more, 20% by mass or more, 25% by mass or more, 30% by mass or more, 35% by mass or more, 40% by mass or more, 45% by mass or more, 50% by mass or more, or 55% by mass or more, from the viewpoint of easily obtaining a high reflectance. The content of the zirconium oxide particles may be less than 100% by mass, 90% by mass or less, 80% by mass or less, 75% by mass or less, 70% by mass or less, 65% by mass or less, or 60% by mass or less, from the viewpoint of easily obtaining a high reflectance. The content of the zirconium oxide particles may be 55% by mass or less, 50% by mass or less, 45% by mass or less, 40% by mass or less, 35% by mass or less, or 30% by mass or less. From these viewpoints, the content of the zirconium oxide particles may be more than 0% by mass and less than 100% by mass, 10 to 80% by mass, 20 to 70% by mass, 25 to 65% by mass, 30 to 65% by mass, 50 to 65% by mass, 25 to 50% by mass, 25 to 40% by mass, or 30 to 50% by mass.

The base material of the composition for ultraviolet light reflection of the present embodiment contains a fluororesin. The fluororesin is a resin containing a fluorine atom, and may be a resin having a compound (monomer) containing a fluorine atom as a monomer unit.

As a compound (monomer) providing the monomer unit of the fluororesin, a compound having a carbon-carbon double bond and a fluorine atom can be used, and examples thereof include vinylidene fluoride, tetrafluoroethylene, chlorotrifluoroethylene, hexafluoropropylene, vinyl fluoride, and perfluoroalkyl vinyl ether. That is, the fluororesin can have a compound having a carbon-carbon double bond and a fluorine atom as a monomer unit (monomer unit derived from a compound having a carbon-carbon double bond and a fluorine atom).

The fluororesin may have a compound (monomer) not containing a fluorine atom as a monomer unit. Examples of the compound (monomer) not containing a fluorine atom include ethylene and propylene.

The fluororesin may have at least one selected from the group consisting of vinylidene fluoride and hexafluoropropylene as a monomer unit, from the viewpoint of easily obtaining a high reflectance. That is, the fluororesin may have at least one selected from the group consisting of a monomer unit of vinylidene fluoride (monomer unit derived from vinylidene fluoride) and a monomer unit of hexafluoropropylene (monomer unit derived from hexafluoropropylene), from the viewpoint of easily obtaining a high reflectance. The fluororesin may have vinylidene fluoride and hexafluoropropylene as monomer units, from the viewpoint of easily obtaining a high reflectance.

The content of the monomer unit of the vinylidene fluoride may be in the following range based on the total mass of the monomer unit of the fluororesin. The content of the monomer unit of the vinylidene fluoride may be 50% by mass or more, 60% by mass or more, 65% by mass or more, 70% by mass or more, 75% by mass or more, or 80% by mass or more, from the viewpoint of easily obtaining a high reflectance. The content of the monomer unit of the vinylidene fluoride may be 85% by mass or more or 90% by mass or more. The content of the monomer unit of the vinylidene fluoride may be 100% by mass or less, less than 100% by mass, 95% by mass or less, 90% by mass or less, 85% by mass or less, or 80% by mass or less, from the viewpoint of easily obtaining a high reflectance. From these viewpoints, the content of the monomer unit of the vinylidene fluoride may be 50 to 100% by mass, 50% by mass or more and less than 100% by mass, 60 to 95% by mass, 70 to 95% by mass, 75 to 85% by mass, 85 to 95% by mass, or 80 to 90% by mass.

The content of the monomer unit of the hexafluoropropylene may be in the following range based on the total mass of the monomer unit of the fluororesin. The content of the monomer unit of the hexafluoropropylene may be more than 0% by mass, 1% by mass or more, 5% by mass or more, 10% by mass or more, 15% by mass or more, or 20% by mass or more, from the viewpoint of easily obtaining a high reflectance. The content of the monomer unit of the hexafluoropropylene may be 50% by mass or less, 40% by mass or less, 35% by mass or less, 30% by mass or less, 25% by mass or less, or 20% by mass or less, from the viewpoint of easily obtaining a high reflectance. The content of the monomer unit of the hexafluoropropylene may be 15% by mass or less or 10% by mass or less. From these viewpoints, the content of the monomer unit of the hexafluoropropylene may be more than 0% by mass and 50% by mass or less, 5 to 40% by mass, 5 to 30% by mass, 15 to 25% by mass, 5 to 15% by mass, or 10 to 20% by mass.

The weight average molecular weight of the fluororesin may be 1.0×10⁴ or more, 3.0×10⁴ or more, 5.0×10⁴ or more, 8.0×10⁴ or more, 10.0×10⁴ or more, 12.0×10⁴ or more, 14.0×10⁴ or more, or 14.4×10⁴ or more, from the viewpoint of easily obtaining a high reflectance. The weight average molecular weight of the fluororesin may be 14.5×10⁴ or more, 14.8×10⁴ or more, or 14.9×10⁴ or more. The weight average molecular weight of the fluororesin may be 50.0×10⁴ or less, 40.0×10⁴ or less, 30.0×10⁴ or less, 20.0×10⁴ or less, 18.0×10⁴ or less, 16.0×10⁴ or less, 15.0×10⁴ or less, 14.9×10⁴ or less, 14.8×10⁴ or less, 14.5×10⁴ or less, or 14.4×10⁴ or less, from the viewpoint of easily obtaining a high reflectance. From these viewpoints, the weight average molecular weight of the fluororesin may be 1.0×10⁴ to 50.0×10⁴, 5.0×10⁴ to 30.0×10⁴, 10.0×10⁴ to 20.0×10⁴, 10.0×10⁴ to 14.5×10⁴, 14.5×10⁴ to 20.0×10⁴, or 12.0×10⁴ to 18.0×10⁴. The weight average molecular weight of the fluororesin can be measured by the method described in Examples below.

The base material may contain a component other than the fluororesin and a volatile content (such as water and an organic solvent) described below. Examples of such a component include a resin component other than the fluororesin; and a (meth) acrylate compound (a compound having an acryloyl group or a methacryloyl group; for example, a (meth) acrylate compound in which an alicyclic hydrocarbon group having 6 or more carbon atoms is ester-bonded). Examples of the resin component other than the fluororesin include polysiloxane and a polysiloxane derivative (for example, organopolysiloxane). The base material may not contain at least one selected from the group consisting of polysiloxane and a polysiloxane derivative. The composition for ultraviolet light reflection of the present embodiment may contain inorganic particles other than the zirconium oxide particles. The composition for ultraviolet light reflection of the present embodiment may not contain at least one selected from the group consisting of particles containing a fluoride of an alkaline earth metal, particles containing boron nitride, particles containing titanium oxide, and particles containing silicon oxide.

The composition for ultraviolet light reflection of the first embodiment is an embodiment in which the base material is in a liquid state at 23° C. (embodiment having fluidity). The composition for ultraviolet light reflection of the first embodiment may be used as a coating material, and may be used for obtaining a film-shaped composition for ultraviolet light reflection.

The composition for ultraviolet light reflection of the first embodiment may contain a volatile content such as water or an organic solvent. Examples of the organic solvent include acetone, methyl ethyl ketone, methyl isobutyl ketone, N,N-dimethylformamide, N,N-dimethylacetamide, dimethyl sulfoxide, N-methyl-2-pyrrolidone, toluene, xylene, methyl acetate, ethyl acetate, butyl acetate, 2-methoxyethanol, 2-ethoxyethanol, 2-propoxyethanol, 2-butoxyethanol, 1-methoxy-2-propanol, 1-ethoxy-2-propanol, 1-propoxy-2-propanol, methanol, ethanol, 1-propanol, 2-propanol (also known as: isopropyl alcohol), 1-butanol, 2-butanol, acetaldehyde, and propionaldehyde. The base material may contain water and an organic solvent. The base material may contain one kind of organic solvents alone, and may contain two or more kinds of organic solvents. The organic solvent may include N,N-dimethylformamide from the viewpoint of excellent solubility of the fluororesin.

In the composition for ultraviolet light reflection of the first embodiment, the content of the zirconium oxide particles may be in the following range based on the total mass (including the mass of the volatile content) of the composition for ultraviolet light reflection. The content of the zirconium oxide particles may be 0.1% by mass or more, 0.5% by mass or more, 1% by mass or more, 2% by mass or more, 3% by mass or more, 3.5% by mass or more, 4% by mass or more, 5% by mass or more, 6% by mass or more, 7% by mass or more, 7.5% by mass or more, 8% by mass or more, 9% by mass or more, 10% by mass or more, 11% by mass or more, 12% by mass or more, or 12.5% by mass or more, from the viewpoint of easily obtaining a high reflectance. The content of the zirconium oxide particles may be 30% by mass or less, 25% by mass or less, 20% by mass or less, 18% by mass or less, 15% by mass or less, or 13% by mass or less, from the viewpoint of easily obtaining a high reflectance. The content of the zirconium oxide particles may be 12.5% by mass or less, 12% by mass or less, 11% by mass or less, 10% by mass or less, 9% by mass or less, 8% by mass or less, 7.5% by mass or less, 7% by mass or less, 6% by mass or less, 5% by mass or less, or 4% by mass or less. From these viewpoints, the content of the zirconium oxide particles may be 0.1 to 30% by mass, 0.1 to 15% by mass, 0.1 to 10% by mass, 0.1 to 5% by mass, 1 to 30% by mass, 1 to 15% by mass, 1 to 10% by mass, 1 to 5% by mass, 5 to 30% by mass, 5 to 15% by mass, 5 to 10% by mass, 8 to 30% by mass, or 8 to 15% by mass.

In the composition for ultraviolet light reflection of the first embodiment, as a content B, the content of the base material (solid content) or the content of the fluororesin may be in the following range based on the total mass (including the mass of the volatile content) of the composition for ultraviolet light reflection. The content B may be 0.1% by mass or more, 0.5% by mass or more, 1% by mass or more, 2% by mass or more, 3% by mass or more, 4% by mass or more, 5% by mass or more, 6% by mass or more, 7% by mass or more, 8% by mass or more, or 8.5% by mass or more, from the viewpoint of easily obtaining a high reflectance. The content B may be 9% by mass or more, 9.2% by mass or more, or 9.5% by mass or more. The content B may be 30% by mass or less, 25% by mass or less, 20% by mass or less, 18% by mass or less, 15% by mass or less, 12% by mass or less, 10% by mass or less, 9.5% by mass or less, 9.2% by mass or less, or 9% by mass or less, from the viewpoint of easily obtaining a high reflectance. From these viewpoints, the content B may be 0.1 to 30% by mass, 0.1 to 20% by mass, 0.1 to 10% by mass, 1 to 30% by mass, 1 to 20% by mass, 1 to 10% by mass, 5 to 30% by mass, 5 to 20% by mass, or 5 to 10% by mass.

The composition for ultraviolet light reflection of the second embodiment is an embodiment of a film-shaped composition for ultraviolet light reflection. The composition for ultraviolet light reflection of the second embodiment can be used as an ultraviolet light reflection film. The composition for ultraviolet light reflection of the second embodiment can be obtained by drying a coating film of the composition for ultraviolet light reflection of the first embodiment. The mass ratio of the zirconium oxide particles and the fluororesin in the composition for ultraviolet light reflection of the first embodiment can be maintained in a film-shaped composition for ultraviolet light reflection (the composition for ultraviolet light reflection of the second embodiment) obtained using the composition for ultraviolet light reflection of the first embodiment.

The average film thickness of the composition for ultraviolet light reflection of the second embodiment may be in the following range. The average film thickness may be 10 μm or more, 30 μm or more, 50 um or more, 80 μm or more, 100 μm or more, 120 μm or more, 140 μm or more, 150 μm or more, 160 μm or more, 170 μm or more, 180 μm or more, 190 μm or more, 200 μm or more, or 210 μm or more. The average film thickness may be 500 μm or less, 450 μm or less, 400 μm or less, 350 μm or less, 300 μm or less, 250 μm or less, 230 μm or less, 210 μm or less, 200 μm or less, 190 μm or less, 180 μm or less, or 170 um or less. From these viewpoints, the average film thickness may be 10 to 500 μm, 30 to 500 μm, 50 to 500 μm, 50 to 300 μm, 100 to 500 μm, 120 to 400 μm, 150 to 300 μm, 170 to 250 μm, 170 to 210 μm, 100 to 180 μm, or 190 to 250 μm. As the average film thickness, an average value of film thicknesses at any five locations can be used.

In the composition for ultraviolet light reflection of the second embodiment, the content of the zirconium oxide particles may be in the following range based on the total volume (total volume of solid content) of the composition for ultraviolet light reflection, the total volume of the zirconium oxide particles and the base material (solid content), or the total volume of the zirconium oxide particles and the fluororesin. The content of the zirconium oxide particles may be more than 0% by volume, 1% by volume or more, 3% by volume or more, 5% by volume or more, 8% by volume or more, 10% by volume or more, 15% by volume or more, 20% by volume or more, 25% by volume or more, or 30% by volume or more, from the viewpoint of easily obtaining a high reflectance. The content of the zirconium oxide particles may be less than 100% by volume, 90% by volume or less, 80% by volume or less, 70% by volume or less, 60% by volume or less, 50% by volume or less, 45% by volume or less, 40% by volume or less, 35% by volume or less, or 30% by volume or less, from the viewpoint of easily obtaining a high reflectance. The content of the zirconium oxide particles may be 25% by volume or less, 20% by volume or less, 15% by volume or less, or 10% by volume or less. From these viewpoints, the content of the zirconium oxide particles may be more than 0% by volume and less than 100% by volume, 1 to 80% by volume, 3 to 60% by volume, 5 to 50% by volume, 5 to 40% by volume, 10 to 40% by volume, 10 to 30% by volume, 10 to 20% by volume, 20 to 30% by volume, 5 to 15% by volume, 15 to 25% by volume, or 25 to 35% by volume.

In the composition for ultraviolet light reflection of the second embodiment, as a content C, the content of the base material (solid content) or the content of the fluororesin may be in the following range based on the total volume (total volume of solid content) of the composition for ultraviolet light reflection, the total volume of the zirconium oxide particles and the base material (solid content), or the total volume of the zirconium oxide particles and the fluororesin. The content C may be more than 0% by volume, 10% by volume or more, 20% by volume or more, 30% by volume or more, 40% by volume or more, 50% by volume or more, 55% by volume or more, 60% by volume or more, 65% by volume or more, or 70% by volume or more, from the viewpoint of easily obtaining a high reflectance. The content C may be 75% by volume or more, 80% by volume or more, 85% by volume or more, or 90% by volume or more. The content C may be less than 100% by volume, 99% by volume or less, 97% by volume or less, 95% by volume or less, 92% by volume or less, 90% by volume or less, 85% by volume or less, 80% by volume or less, 75% by volume or less, or 70% by volume or less, from the viewpoint of easily obtaining a high reflectance. From these viewpoints, the content C may be more than 0% by volume and less than 100% by volume, 20 to 99% by volume, 40 to 97% by volume, 50 to 95% by volume, 60 to 95% by volume, 60 to 90% by volume, 70 to 90% by volume, 80 to 90% by volume, 70 to 80% by volume, 85 to 95% by volume, 75 to 85% by volume, or 65 to 75% by volume.

A laminate of the present embodiment has the composition for ultraviolet light reflection of the second embodiment and a substrate supporting this composition for ultraviolet light reflection. The laminate of the present embodiment may be obtained by disposing (for example, applying) the composition for ultraviolet light reflection of the first embodiment on a substrate and then drying the composition for ultraviolet light reflection, and may be obtained by disposing the composition for ultraviolet light reflection of the second embodiment on a substrate. The shape, material, and the like of the substrate are not particularly limited. Examples of the material of the substrate include organic materials such as polyolefin (for example, polypropylene), polycarbonate, and an acrylic resin; and inorganic materials such as glass. The surface, which comes into contact with the composition for ultraviolet light reflection, of the substrate is not particularly limited, and may be a flat surface, a curved surface, an uneven surface, or the like.

A method for producing a composition for ultraviolet light reflection of the present embodiment includes a mixing step of mixing a base material and zirconium oxide particles, in which the base material contains a fluororesin and a particle diameter D50 of the zirconium oxide particles is 10 μm or less. In the method for producing a composition for ultraviolet light reflection of the present embodiment, the range of the particle diameter D50 may be any of the ranges described above for the composition for ultraviolet light reflection of the present embodiment. In the mixing step, a composition for ultraviolet light reflection can be obtained by dispersing zirconium oxide particles in a base material. The method for producing a composition for ultraviolet light reflection of the present embodiment may include a step of molding the composition for ultraviolet light reflection into a film shape after the mixing step. A method for producing a laminate of the present embodiment includes a step of bringing a composition for ultraviolet light reflection obtained by the method for producing a composition for ultraviolet light reflection of the present embodiment into contact with a substrate.

### EXAMPLES

Hereinafter, the present invention will be more specifically described by means of Examples; however, the present invention is not limited to these Examples.

### Preparation of Coating Material

A coating material was obtained by mixing a filler and a resin material shown in Table 1, and N,N-dimethylformamide (organic solvent). The blended amount (based on the total mass of the coating material) of each component is shown in Table 1. The components used are as follows.

### (Filler)

Zirconium oxide A: trade name “UEP-100” manufactured by DAIICHI KIGENSO KAGAKU KOGYO CO., LTD., refractive index: 2.05, crystallite size: 102 Å, BET specific surface area: 90 m²/g
Zirconium oxide B: trade name “UEP” manufactured by DAIICHI KIGENSO KAGAKU KOGYO CO., LTD., refractive index: 2.05, crystallite size: 229 Å, BET specific surface area: 22 m²/g
Zirconium oxide C: trade name “BR-12QZ” manufactured by DAIICHI KIGENSO KAGAKU KOGYO CO., LTD., refractive index: 2.05, BET specific surface area: 1.5 m²/g
Titanium oxide: trade name “TTO-51” manufactured by ISHIHARA SANGYO KAISHA, LTD., refractive index: 2.5, BET specific surface area: 50 to 60 m²/g
Silicon oxide: trade name “UFP-30” manufactured by Denka Company Limited, refractive index: 1.4 to 1.5, BET specific surface area: 40 m²/g

### (Resin Material)

Resin material A: vinylidene fluoride-hexafluoropropylene copolymer, trade name “Kynar Flex 2821-00” manufactured by ARKEMA K.K., ratio of monomer unit of vinylidene fluoride: 90% by mass, weight average molecular weight: 14.9×10⁴
Resin material B: vinylidene fluoride-hexafluoropropylene copolymer: trade name “Kynar Flex 2500-20” manufactured by ARKEMA K.K., ratio of monomer unit of vinylidene fluoride: 80% by mass, weight average molecular weight: 14.4×10⁴

The particle diameter D50 of the filler was measured according to the following procedure. First, a dispersion treatment (pretreatment) was performed using water as a solvent and applying a power of 200 W by a homogenizer. Next, the particle size distribution was measured by a laser diffraction scattering method in accordance with JIS R 1629:1997 using trade name “LS-230” manufactured by Beckman Coulter, Inc. Then, the particle diameter D50 was determined from the particle size distribution. The measurement results are shown in Table 1.

The aforementioned refractive index of the filler was measured using an Abbe refractometer (trade name: KPR-30A manufactured by SHIMADZU CORPORATION).

The aforementioned crystallite size of the filler was measured by the following procedure. X-ray diffraction was performed by an X-ray diffractometer (trade name: Ultima IV manufactured by Rigaku Corporation) using CuKa rays under the conditions of an applied voltage of 40 kV, an applied current of 40 mA, a measurement range 2θ=10 to 80°, a sampling width of 0.02°, a scanning speed of 1°/min, an incident-side solar slit of 5.0°, a light-receiving side solar slit of 5.0°, DS 2/3°, DS height of 10 mm, SS 8 mm, RS open, a Ni filter thickness of 15 μm, and a scattering prevention tube slit width of 4 mm. Analysis was performed using integrated X-ray powder diffraction software PDXL manufactured by Rigaku Corporation by the Halder-Wagner method, and the crystallite size of the filler was calculated.

The aforementioned BET specific surface area of the filler was measured using a fully automatic specific surface area analyzer (trade name: Macsorb Model HM 1201 manufactured by Mountech Co., Ltd.) by a single point BET method by a carrier gas method using nitrogen (adsorptive medium: N₂, adsorption temperature: −196° C., pretreatment conditions: treatment at 100° C. for 60 minutes).

The ratio of the monomer unit of the aforementioned vinylidene fluoride of the resin material was measured by 19F-NMR under the following conditions.
Apparatus used: trade name “ECP-300” manufactured by JEOL Ltd.
Resonance frequency: 282 MHZ (19F-NMR)
Measurement temperature: 80° C.
Dissolution solvent: DMSO-d6
Internal standard material: hexafluorobenzene (−162.9 ppm)
Cumulative number: 16 times

The aforementioned weight average molecular weight of the resin material was measured by gel permeation chromatography (GPC) under the following conditions and calculated as the molecular weight in terms of polyethylene oxide, polyethylene glycol, and tetraethylene glycol.
Apparatus used: Pump shodex DS-4
   Column shodex GPC KD-806M×2+KD-802
   Detector shodex RI-101
Eluent: N,N-dimethylformamide (additive: lithium bromide 10 mmol/L)
Pretreatment: filtration with a membrane filter (pore size: 0.2 μm)
Concentration: 0.2 w/v %
Injection volume: 100 μL
Column temperature: 50° C.
Flow rate: 1.0 mL/min

### Production of Coating Film

A coating film (reflection film) was produced using the aforementioned coating material according to the following procedure. First, 2 mL of the coating material was dropped onto a glass substrate, and then coating was performed with a film thickness of 1 mm using a film applicator (manufactured by TESTER SANGYO CO., LTD.) provided with a micrometer to obtain an undried film. Thereafter, a laminate of the undried film and the glass substrate was dried for 4 hours on a hot plate heated to 60° C. to obtain a coating film. The contents (the contents based on the total mass or total volume of the solid content of the coating film) of the resin material and the filler in the coating film are shown in Table 1. The content based on the total volume of the solid content of the coating film was calculated based on the volume calculated by dividing the used amount of each component by the specific gravity.

The average film thickness of the aforementioned coating film was measured using trade name “Digital Indicator” manufactured by Magnescale Co., Ltd. The average value of film thicknesses at five locations was obtained as the average film thickness. The measurement results are shown in Table 1.

### Evaluation of Reflectance

The reflectance (average value of reflectance with respect to light having a wavelength of 270 to 280 nm) of the aforementioned coating film was measured using an ultraviolet-visible spectrophotometer (trade name: SolidSpec-3700 manufactured by SHIMADZU CORPORATION). The measurement results are shown in Table 1. In Examples, it is found that a high reflectance with respect to light having a wavelength of 270 to 280 nm is obtainable.

TABLE 1

| | | Example | | | | | | | Comparative Example | | | |
|---|---|---|---|---|---|---|---|---|---|---|---|---|
| | | 1 | 2 | 3 | 4 | 5 | 6 | 7 | 1 | 2 | 3 | 4 |
| Filler | Type | Zirconium oxide A | | | | Zirconium oxide B | | | — | Zirconium oxide C | Titanium oxide | Silicon oxide |
| | D50 [μm] | 0.4 | | | | 0.6 | | | | 10.8 | 0.01 to 0.03 | 0.1 |
| Type of resin material | | A | | | B | A | | | | | | |
| Content in | Filler | 3.6 | 7.8 | 12.9 | 3.6 | 3.6 | 7.8 | 12.9 | 0 | 3.6 | 3.6 | 6.0 |
| coating material | Resin material | 9.6 | 9.2 | 8.7 | 9.6 | 9.6 | 9.2 | 8.7 | 10.0 | 9.6 | 9.6 | 9.4 |
| [mass %] | Solvent | 86.8 | 83.0 | 78.4 | 86.8 | 86.8 | 83.0 | 78.4 | 90.0 | 86.8 | 86.8 | 84.6 |
| Content in | Filler | 27.3 | 45.9 | 59. | 27.3 | 27.3 | 45.9 | 59.7 | 0 | 27.3 | 27.3 | 39.0 |
| coating film | | | | | | | | | | | | |
| [mass %] | Resin material | 72.7 | 54.1 | 40.3 | 72.7 | 72.7 | 54.1 | 40.3 | 100 | 72.7 | 72.7 | 61.0 |
| Content in | Filler | 10 | 20 | 30 | 10 | 10 | 20 | 30 | 0 | 10 | 10 | 30 |
| coating film | | | | | | | | | | | | |
| [vol %] | Resin material | 90 | 80 | 70 | 90 | 90 | 80 | 70 | 100 | 90 | 90 | 70 |

| | | | | | | | | | | | |
|---|---|---|---|---|---|---|---|---|---|---|---|
| Film thickness of coating film | 170 | 180 | 180 | 170 | 210 | 190 | 200 | 160 | 170 | 100 | 150 |
| [μm] | | | | | | | | | | | |
| Reflectance [%] | 68.2 | 68.7 | 69.8 | 72.3 | 84.8 | 87.5 | 88.3 | 6.5 | 30.1 | 5.4 | 29.5 |

1. A composition for ultraviolet light reflection, the composition comprising a base material and zirconium oxide particles dispersed in the base material, wherein
the base material contains a fluororesin, and
a particle diameter D50 of the zirconium oxide particles is 10 μm or less.

2. The composition for ultraviolet light reflection according to claim 1, wherein the particle diameter D50 of the zirconium oxide particles is 0.1 to 10 μm.

3. The composition for ultraviolet light reflection according to claim 1, wherein the particle diameter D50 of the zirconium oxide particles is 0.1 to 1.0 μm.

4. The composition for ultraviolet light reflection according to claim 1, wherein a content of the zirconium oxide particles is 20 to 70% by mass based on the total mass of the zirconium oxide particles and the fluororesin.

5. The composition for ultraviolet light reflection according to claim 1, wherein the fluororesin has at least one selected from the group consisting of vinylidene fluoride and hexafluoropropylene as a monomer unit.

6. The composition for ultraviolet light reflection according to claim 5, wherein the fluororesin has vinylidene fluoride and hexafluoropropylene as monomer units.

7. The composition for ultraviolet light reflection according to claim 5, wherein a content of the monomer unit of the vinylidene fluoride is 70 to 95% by mass based on the total mass of the monomer unit of the fluororesin.

8. The composition for ultraviolet light reflection according to claim 1, wherein the base material is in a liquid state at 23° C.

9. The composition for ultraviolet light reflection according to claim 8, wherein the base material further contains an organic solvent.

10. The composition for ultraviolet light reflection according to claim 1, which has a film shape.

11. The composition for ultraviolet light reflection according to claim 10, wherein an average film thickness is 50 to 500 μm.

12. The composition for ultraviolet light reflection according to claim 10, wherein a content of the zirconium oxide particles is 10 to 40% by volume.

13. The composition for ultraviolet light reflection according to claim 1, wherein the particle diameter D50 of the zirconium oxide particles is more than 0.2 μm and 10 μm or less.

14. The composition for ultraviolet light reflection according to claim 1, wherein the particle diameter D50 of the zirconium oxide particles is more than 0.2 μm and less than 1.0 μm.

15. The composition for ultraviolet light reflection according to claim 1, wherein the particle diameter D50 of the zirconium oxide particles is 0.4 to 10 μm.

16. The composition for ultraviolet light reflection according to claim 1, wherein a content of the zirconium oxide particles is 5% by mass or more and less than 100% by mass based on the total mass of the zirconium oxide particles and the fluororesin.

17. The composition for ultraviolet light reflection according to claim 1, wherein a content of the zirconium oxide particles is 10% by mass or more and less than 100% by mass based on the total mass of the zirconium oxide particles and the fluororesin.

18. The composition for ultraviolet light reflection according to claim 1, wherein a content of the zirconium oxide particles is 20% by mass or more and less than 100% by mass based on the total mass of the zirconium oxide particles and the fluororesin.

19. The composition for ultraviolet light reflection according to claim 10, wherein an average film thickness is 140 μm or more.
